(19) United States
(12) Patent Application Publication
(10) Pub. No.: US 2026/0271034 A1
(43) Pub. Date: Sep. 10, 2026

(54) METHODS AND APPARATUSES FOR ENABLING A DONOR ACCESS POINT TO SHARE A TRANSMISSION OPPORTUNITY WITH OTHER CO-CHANNEL RECIPIENT ACCESS POINTS

(71) Applicant: NOKIA TECHNOLOGIES OY, Espoo (FI)

(72) Inventors: Kerstin JOHNSSON, Palo Alto, CA (US); Klaus Franz DOPPLER, Albany, CA (US); Salvatore TALARICO, Sunnyvale, CA (US); Behnam DEZFOULI, San Jose, CA (US); Mikhail LIUBOGOSHCHEV, Munich (DE); Orhan Okan MUTGAN, Munich (DE)

(73) Assignee: NOKIA TECHNOLOGIES OY, Espoo (FI)

(21) Appl. No.: 19/554,906

(22) Filed: Mar. 3, 2026

Related U.S. Application Data
(60) Provisional application No. 63/766,933, filed on Mar. 4, 2025.

(51) Int. Cl. H04W 72/29; H04W 72/30; H04W 74/00

(52) U.S. Cl. CPC H04W 72/29; H04W 72/30; H04W 74/002

(57) ABSTRACT

A method, apparatus and computer program product are provided to aggregate multiple transmission opportunity (TxOP) handover operations into a single control exchange. An access point (AP) that is to share a TxOP may therefore transmit a single trigger frame to multiple coordinating APs at one time. The trigger frame identifies the AP that is sharing the TxOP, defines the frequency resources and the allocation starttime for the allocation of the TxOP, and defines the duration of the allocation of the TxOP. If a respective coordinating AP that is sharing the TxOP has completed its use of the allocated portion of the TxOP early the coordinating AP or the AP that is sharing the TxOP may relinquish the allocation of the TxOP by triggering a handover to another AP that is next in allocation order.

### CROSS-REFERENCE TO RELATED APPLICATIONS

This application claims the benefit of U.S. Provisional Application No. 63/766,933, filed Mar. 4, 2025, the entire contents of which are incorporated herein by reference.

### TECHNICAL FIELD

Various example embodiments relate generally to communication systems and, more particularly, to wireless network functionality related to sharing a transmission opportunity between a plurality of access points.

### BACKGROUND

Wireless communication networks, such as Wi-Fi networks, may support latency-sensitive applications at Wi-Fi stations (STAs). Such latency-sensitive applications may include virtual reality (VR) applications, mixed reality (MR) applications, augmented reality (AR) applications, extended reality (XR) applications, or applications that utilize sensors which detect events to be reported with low latency. However, in some cases, the limited reliability and the non-deterministic channel access of a wireless communication network may constrain the performance of the latency-sensitive applications and/or the wireless communication network.

As a result, IEEE 802.11bn will allow access points (APs) to use coordinated time division multiple access (C-TDMA) to share a transmission opportunity (TxOP) with another AP and its associated non-AP stations (STAs) in an instance in which an AP completed its use of the TxOP early prior to the conclusion of the TxOP. Sharing a TxOP allows for more efficient use of the spectrum, reduces interference and provides APs that are compliant with IEEE 802.11bn to have more transmission opportunities to serve low latency traffic than prior techniques in which an AP would send a contention-free (CF) end frame and require the other APs to contend for a new TxOP even in an instance in which the AP completed its use of the TxOP early prior to the conclusion of the TxOP.

Referring to FIG. 1, the signaling between APs to support C-TDMA is depicted, thereby allowing AP1 to share its TxOP with either AP2 or AP3. During the polling phase, AP1 transmits an initial control frame 100 to its coordinating APs that are operating in the same bandwidth. Coordinating APs have pre-negotiated various C-TDMA parameters during a C-TDMA initialization protocol. The initial control frame is a trigger-based physical layer protocol data unit (PPDU). The initial control frame invites the coordinating APs to respond if the coordinating APs wish to share the TxOP.

The coordinating APs respond to the initial control frame with a control frame response as shown at 102 indicating whether the coordinating AP would like to share in the TxOP. These responses may include information such as their buffer sizes per access category. Following the receipt of the control frame responses from the coordinating APs, the AP1 then exchanges frames with one or more non-AP stations with which AP1 is in communication as shown at 104, such as by exchanging uplink and downlink transmissions with the associated non-AP stations. In an instance in which the uplink and downlink transmissions of AP1 are completed prior to the end of the TxOP, AP1 transmits at 106 a multi-user request-to-send transmission opportunity sharing trigger frame (MU-RTS TXS) to one of the coordinating APs that previously responded with a control frame indicating an interest in sharing in the TxOP. The trigger frame includes an identifier of the coordinating AP, e.g., AP3, with which the TxOP is to be shared, the frequency resources to be used, and the duration of the TxOP allocation being shared with the coordinating AP. Upon receiving the trigger frame, AP3 returns a response to AP1, such as a clear to send (CTS) response, and then proceeds to utilize the allocated portion of the TxOP for its own downlink and uplink transmissions with one or more non-AP stations that are in communication with AP3. See blocks 108, 110. If the AP3 completes its transmissions prior to expiration of its TxOP allocation, AP3 will provide a TxOP return frame to AP1, as shown at 112, indicating that the remainder of the TxOP allocation to AP3 is being returned to AP1 such that AP1 can then utilize the remainder itself or share the remainder of the TxOP with another AP.

The C-TDMA protocol depicted in FIG. 1 allows an AP, such as AP1, to concurrently poll multiple coordinating APs, such as AP2, AP3, to determine whether the coordinating APs would like to share in the TxOP. However, AP1 can only share and can only hand over the TxOP to one coordinating AP at a time. Each handover requires the transmission of a trigger frame from the AP sharing part of its TxOP, such as AP1, and a response from the AP being offered part of the TxOP, such as AP3. Additionally, if the AP that is sharing a part of AP1’s TxOP, such as AP3, completes its transmissions prior to the end of the TxOP allocation assigned by AP1, it provides a TxOP return frame to AP1 indicating that the remainder of the allocated portion of the TxOP is being returned for use by AP1 or for sharing by AP1 with another coordinating AP. As such, for AP1 to share the TxOP with another coordinating AP, AP1 must repeat the entire signaling sequence, namely, the transmission of a trigger frame by AP1 and the response from the coordinating AP and, in some instances the transmission of a return frame by the coordinating AP. This repeated control signaling that is required to share the TxOP with additional coordinating APs undesirably increases the signalling overhead and consumes airtime.

### BRIEF DESCRIPTION

In one embodiment, an apparatus is provided that includes at least one processor and at least one memory storing instructions that, when executed by the at least one processor, cause the apparatus to utilize a portion of a transmission opportunity (TxOP) of a donor access point to exchange frames with one or more associated non-AP stations with which a recipient access point is in communication. Upon completing utilization of the TxOP prior to an end of the TxOP allocation specified by the donor access point for use by the apparatus, the apparatus is also caused to transmit a TxOP return frame to relinquish the TxOP.

In another embodiment, a method is provided that includes utilizing a portion of a transmission opportunity (TxOP) of a donor access point to exchange frames with one or more associated non-AP stations with which a recipient access point is in communication. Upon completing utilization of the TxOP prior to an end of the TxOP allocation specified by the donor access point for use by a recipient access point, the method also includes transmitting a TxOP return frame to relinquish the TxOP.

In a further example embodiment, a non-transitory computer-readable storage medium is provided that includes program instructions stored thereon that are configured to utilize a portion of a transmission opportunity (TxOP) of a donor access point to exchange frames with one or more associated non-AP stations with which a recipient access point is in communication. Upon completing utilization of the TxOP prior to an end of the TxOP allocation specified by the donor access point for use by a recipient access point, the program instructions are also configured to transmit a TxOP return frame to relinquish the TxOP.

In yet another embodiment, an apparatus is provided that includes means for utilizing a portion of a transmission opportunity (TxOP) of a donor access point to exchange frames with one or more associated non-AP stations with which a recipient access point is in communication. Upon completing utilization of the TxOP prior to an end of the TxOP allocation specified by the donor access point for use by a recipient access point, the apparatus also includes means for transmitting a TxOP return frame to relinquish the TxOP.

In an example embodiment, transmitting the TxOP return frame may include broadcasting the TxOP return frame. In this embodiment, the TxOP return frame that is broadcast identifies the recipient access point that is relinquishing the TxOP prior to an end of its TxOP allocation. Transmitting the TxOP return frame may include broadcasting, multicasting or unicasting the TxOP return frame. In this embodiment, the TxOP return frame may include an identity of another recipient access point. The another recipient access point may immediately follows the recipient access point in TxOP allocation order. In an example embodiment, transmitting the TxOP return frame includes multicasting the TxOP return frame to the donor access point and to another recipient access point that is next in TxOP allocation order. In this embodiment, the TxOP includes an identity of the another recipient access point that is next in TxOP allocation order.

In one embodiment, an apparatus is provided that includes at least one processor and at least one memory storing instructions that, when executed by the at least one processor, cause the apparatus to receive a TxOP return frame from a recipient access point that is currently sharing the TxOP of the apparatus prior to an end of a TxOP allocation of the recipient access point. The apparatus is also caused to determine whether to transmit another TxOP return frame indicating that the TxOP is now being shared with another recipient access point that is next in an TxOP allocation order prior to an allocation start time assigned to the another recipient access point.

In another embodiment, a method is provided that includes receiving a TxOP return frame from a recipient access point that is currently sharing the TxOP of a donor access point prior to an end of a TxOP allocation of the recipient access point. The method also includes determining whether to transmit another TxOP return frame indicating that the TxOP is now being shared with another recipient access point that is next in an TxOP allocation order prior to an allocation start time assigned to the another recipient access point.

In a further example embodiment, a non-transitory computer-readable storage medium is provided that includes program instructions stored thereon that are configured to receive a TxOP return frame from a recipient access point that is currently sharing the TxOP of a donor access point prior to an end of a TxOP allocation of the recipient access point. The program instructions are also configured to determine whether to transmit another TxOP return frame indicating that the TxOP is now being shared with another recipient access point that is next in an TxOP allocation order prior to an allocation start time assigned to the another recipient access point.

In yet another embodiment, an apparatus is provided that includes means for receiving a TxOP return frame from a recipient access point that is currently sharing the TxOP of a donor access point prior to an end of a TxOP allocation of the recipient access point. The apparatus also includes means for determining whether to transmit another TxOP return frame indicating that the TxOP is now being shared with another recipient access point that is next in an TxOP allocation order prior to an allocation start time assigned to the another recipient access point.

In an example embodiment, determining whether to transmit another TxOP return frame includes determining whether the recipient access point from which the TxOP return frame was received is last in the TxOP allocation order and determining to transmit the another TxOP return frame other than in an instance in which the recipient access point is last in the TxOP allocation order for the TxOP. The method, apparatus and computer program product may also include delaying by a short interface space (SIFS) prior to transmitting the another TxOP return frame. In one embodiment, the method, the method, apparatus and computer program product may also include transmitting the another TxOP return frame by broadcasting the another TxOP return frame, wherein the another TxOP return frame includes an identity of at least one of the recipient access point relinquishing the TxOP or the another recipient access point that is next in the TxOP allocation order. The method, apparatus and computer program product may also include transmitting the another TxOP return frame by multicasting or unicasting the another TxOP return frame to the another recipient access point that is next in the TxOP allocation order. In an example embodiment, the method, apparatus and computer program product may also include transmitting an indication as to whether the another recipient access point must wait for a TxOP return frame from the recipient access point immediately preceding the another recipient access point in the TxOP allocation order or from the donor access point before commencing utilization of the TxOP prior to a start of the TxOP allocation of the another recipient access point.

Determining whether to transmit the another TxOP return frame includes determining whether the another recipient access point that is next in the TxOP allocation order is in communication range of the recipient access point that sent the TxOP return frame and determining to transmit the another TxOP return frame only in an instance in which the another recipient access point is outside of the communication range of the recipient access point that sent the TxOP return frame. In an example embodiment, determining whether to transmit the another TxOP return frame includes determining whether time remaining before an end of the TxOP allocation assigned to the recipient access point that sent the TxOP return frame satisfies a predefined threshold and determining to transmit the another TxOP return frame in an instance in which the time remaining exceeds the predefined threshold. The method, apparatus and computer program product may also include, in response to a failure of the another recipient access point to utilize the TxOP within a predefined time out period after the another recipient access point gains access to the TxOP, transmitting a TxOP return frame indicating that the TxOP is now being shared with a further recipient access point that is next in the TxOP allocation order.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 depicts a coordinated time division multiple access (C-TDMA) process;

FIG. 2 illustrates a wireless network that supports communication between non-AP stations and wireless access points;

FIG. 3 is a block diagram of an apparatus configured in accordance with one or more example embodiments of the present disclosure;

FIG. 4 illustrates a User Info field of a trigger frame, such as a multi-user request-to-send transmission opportunity sharing (MU-RTS TXS) trigger frame;

FIG. 5 illustrates the ordering of a plurality of User Info fields associated with different wireless access points to corresponding to the TxOP allocation order in which the wireless access points will share the TxOP in accordance with one or more example embodiments of the present disclosure;

FIG. 6 illustrates a C-TDMA process that has been supplemented in accordance with one or more example embodiments of the present disclosure;

FIG. 7 is a flowchart illustrating the operations performed by a donor AP that is sharing its TxOP with multiple recipient APs, where the TXOP allocation order of those recipient APs is defined by the ordering of their User Info fields within the trigger frame in accordance with one or more example embodiments of the present disclosure;

FIG. 8 is a flowchart illustrating the operations performed by a recipient AP that is next in the TxOP allocation order as defined by the ordering of the User Info fields within the trigger frame in accordance with one or more example embodiments of the present disclosure;

FIG. 9 is a flowchart illustrating the operations performed by a donor AP that is sharing its TxOP with multiple recipient APs, where the TxOP allocation order of those recipient APs is defined by their relative TxOP allocation start times as specified in the Resource Unit (RU) Allocation fields within their User Info fields of the trigger frame in accordance with one or more example embodiments of the present disclosure;

FIG. 10 is a flowchart illustrating the operations performed by a recipient AP that is next in the TxOP allocation order as defined by the TxOP allocation start times specified in the RU Allocation fields within the User Info fields of the trigger frame in accordance with one or more example embodiments of the present disclosure;

FIG. 11 is a flowchart illustrating the operations performed by a recipient AP that is relinquishing the TxOP prior to the end of its TxOP allocation in accordance with one or more example embodiments of the present disclosure; and

FIG. 12 is a flowchart illustrating the operations performed by a donor AP in response to receiving a TxOP return frame from a recipient AP that is relinquishing the TxOP prior to the end of its TxOP allocation in accordance with one or more example embodiments of the present disclosure.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means any, some or all of the following instances: (A), (B), or (A and B). For the purposes of the present disclosure, the phrase “A, B, and/or C” means any, some or all of the following instances: (A), (B), (C), (A and B), (A and C), (B and C), or (A, B, and C).

Some embodiments of the present disclosure will now be described more fully hereinafter with reference to the accompanying drawings, in which some, but not all, embodiments of the present disclosure are shown. Indeed, various embodiments of the present disclosure may be embodied in many different forms and should not be construed as limited to the certain embodiments set forth herein; rather, these certain embodiments are provided so that this disclosure will satisfy applicable legal requirements. Like reference numerals refer to like elements throughout.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

As used herein, the terms “data,” “content,” “information,” and similar terms may be used interchangeably to refer to data capable of being transmitted, received and/or stored in accordance with an embodiment of the present disclosure. Thus, use of any such terms should not be taken to limit the spirit and scope of one or more embodiments of the present disclosure.

A communications system may be deployed in a wireless local area network (e.g., WLAN, Wi-Fi, etc.), for example, based on IEEE 802.11 standards and/or related drafts, such as 802.11-2020, 802.11ac, 802.11ax, 802.11be, 802.11bn, and/or others. That is, the system may be an example of a WLAN system. The WLAN system may support wireless communications between one or more communications devices in accordance with one or more Wi-Fi protocols. In some examples, Wi-Fi communications may occur via one or more radio frequency bands, such as about a 2.4 GHz radio frequency band, a 5GHz radio frequency band, a 6GHz radio frequency band, and/or another radio frequency band. In some such examples, each radio frequency band may support one or more channels over which data may be communicated. In some examples, multiple devices may use multiple channels to communicate over the WLAN simultaneously.

A WLAN system may include one or more communications devices, such as one or more APs and/or one or more non-AP stations (STAs). That is, a device configured to support one or more Wi-Fi protocols may be an example of an AP (e.g., may operate in accordance with an AP mode) and/or may be an example of a non-AP STA (e.g., may operate in accordance with a non-AP STA mode). In some examples, an AP may control Wi-Fi communications for one or more non-AP STAs. For example, an AP may be (or may be connected to) a central entity used to establish (and/or control) one or more connections between one or more non-AP STAs and another network (e.g., the Internet). In other words, in some examples, the AP may connect a wired network (e.g., the Internet) to a wireless network (e.g., the WLAN). In some instances, a Wi-Fi network may be identified via one or more identifiers, such as a service set identifier (SSID).

A WLAN system may support one or more architectures (types of logical relationships between devices). For example, a WLAN system may support an autonomous architecture, a centralized architecture, a cooperative architecture, and/or other types of architectures. In some examples of an autonomous architecture, APs are stand-alone APs configured with features and capabilities to operate without any reliance on another device. In some examples of a centralized architecture, a centralized network manager may regulate the operation of the WLAN. In other words, the network manager may be the AP or may be connected to one or more APs within the WLAN. For example, APs may be connected (e.g., wirelessly and/or via a wired connection) to a central entity which may be configured to act as a network manager. In some examples, the network manager is an entity in cloud-based entity which may reside either in private cloud or in public cloud. In some examples of a cooperative architecture (also referred to as a network manager-less or controller-less architecture), a virtual management (e.g., cloud-based) system may be used to control a WLAN. For example, the virtual management system may employ a cooperative communication method between one or more APs to control the WLAN. In other examples, a centralized network manager may use a wireless system to provide local connection to clients (e.g., non-AP STAs). For example, the centralized network manager may be a controller configured to perform operations related to authentication, authorization, accounting (e.g., via an authentication, authorizing, and accounting (AAA) server), and/or other operations.

Additionally, or alternatively, a WLAN system may support one or more topologies (types of physical connections between various devices within the WLAN system). For example, the WLAN system may support an infrastructure topology which may include a combination of wired and wireless connections. In some examples of an infrastructure topology, the infrastructure topology may include one or more wired devices with a wired connection to a network (e.g., one or more APs that are each connected via a cable to a switch) and the one or more wired devices may support one or more wireless connections to one or more wireless devices (e.g., laptops, tablets, cell phones), such that the wireless devices may connect wirelessly to the network. In other words, the one or more wired devices may serve as a bridge between the wireless network and the wired network. Additionally, or alternatively, the WLAN system may support an ad hoc topology, which does not rely on infrastructure (e.g., cables, routers, servers, or APs). In some examples of an ad hoc network, one or more non-AP STAs (also referred to as clients) may wirelessly connect to other devices in a peer-to-peer network. Additionally, or alternatively, the WLAN system may support a mesh topology in which multiple network devices are interconnected with each other via wireless connections. For example, in accordance with a mesh topology, an AP (e.g., each AP), which may support one or more wireless connections with one or more non-AP STAs, may communicate wirelessly with one or more other APs.

In accordance with one or more Wi-Fi protocols, data may be transmitted wirelessly between two devices (e.g., an AP and a non-AP STA) via packets, referred to as protocol data units (PDUs). In other words, Wi-Fi communications may include transmission and reception of one or more PDUs. For example, data may be communicated via a frame (e.g., a medium access control (MAC) frame), which may include one or more PDUs. In some instances, multiple frames may include the same PDU. In some examples, a PDU may include data (referred to as a payload), as well as one or more headers (e.g., a sequence of one or more fields) and/or one or more trailers (e.g., a sequence of bits appended to the PDU, after the payload). In some examples, the data included in the PDU, may be user data, control data, management data, and/or other types of data. In some examples, frames may include data type frames, control type frames, management type frames, and/or other types of frames. At least one frame type (e.g., each frame type) may be included in a PDUs, wherein a payload of a PDU may comprise user data, control data, management data, and/or other data. In some examples, a WLAN system may implement one or more security protocols to protect the confidentiality, integrity, and availability of Wi-Fi communications.

A WLAN system may be configured with various types of services sets, for example, such as basic service set (BSS) and/or an extended service set (ESS). A BSS may be comprised of an AP and one or more client devices (e.g., non-AP STAs) associated with the AP. The one or more client devices may have one or more common PHY medium access characteristics (e.g., radio frequency, modulation scheme, security settings, and/or the like). A BSS identifier (BSSID) may define the BSS such that the one or more client devices of the BSS share the same BSSID.

A communication network such as a WLAN may support latency-sensitive applications at Wi-Fi stations (STAs). Such latency-sensitive applications may include virtual reality (VR) applications, mixed reality (MR) applications, augmented reality (AR) applications, and extended reality (XR) applications. Latency-sensitive applications may also include applications that utilize sensors which detect events to be reported with low latency. However, in some cases, default procedures for channel access of a communication network (e.g., a WLAN) may constrain performance of the latency-sensitive applications and/or the communication network. For example, low latency support may involve delivering frames with low latency for APs and non-AP STAs. To support low latency traffic, a channel access procedure for a communication network may be modified to provide higher priority access to STA(s) with low latency traffic. As an example, some Wi-Fi devices utilize a Carrier Sense Multiple Access with Collision Avoidance (CSMA/CA) protocol which relies on a backoff mechanism to manage access to a shared wireless channel. In some examples, a contention window (CW) may be utilized to support low latency traffic. For instance, when multiple devices request to transmit data at the same time, each device may select a random backoff time from a defined range called the contention window. Typically, for each access category (AC) there is a minimum Contention Window (CW_min) and a maximum Contention Window (CW_max). For example, Access Category Voice (AC_VO) may be the highest priority access category and the CW_min may be set to 1/4th of CW_min for best effort traffic associated with data traffic where priority is not critical (e.g., web browsing, email, etc.) or background traffic associated with data traffic for low-priority background tasks (e.g., downloading content, etc.). In other examples, exponential backoff may be utilized. For instance, if a collision occurs (e.g., multiple devices transmit simultaneously), the contention window size may be increased exponentially (e.g., increased by 2x until CW_max is reached) for each subsequent transmission attempt, thereby providing more time for other devices to transmit data and reducing the likelihood of further collisions. In other examples, randomization may be utilized. For instance, the random selection of the backoff time within the contention window may be utilized to minimize synchronized transmission attempts from multiple devices, further preventing collisions.

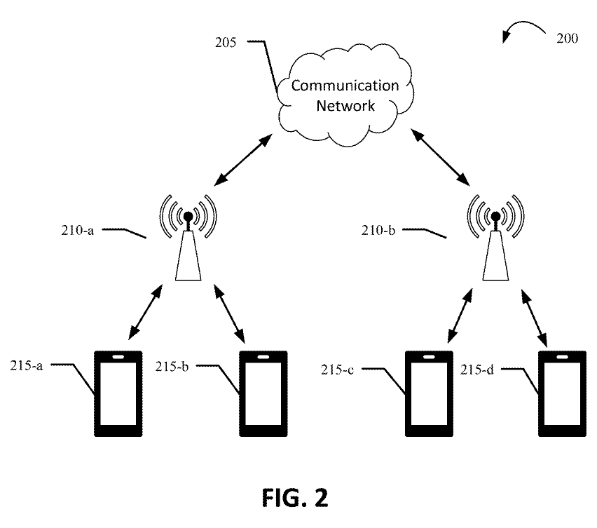

Referring now to FIG. 2, an example communication system 200 is illustrated according to one or more embodiments of the present disclosure. The communication system 200 is a communication system to which one or more examples disclosed herein may be applied. The depiction of the communication system 200 in FIG. 2 is not intended to limit or otherwise confine the example embodiment described and contemplated herein to any particular configuration of elements or systems, nor is it intended to exclude any alternative configurations or systems for the set of configurations and systems that can be used in connection with an example embodiment of the present disclosure. Rather, FIG. 2, and the communication system 200 disclosed therein is merely presented to provide an example basis and context for the facilitation of some of the features, aspects, and uses of the methods, apparatuses, and computer program products disclosed and contemplated herein. It will be understood that while many of the aspects and components presented in FIG. 2 are shown as discrete, separate elements, other configurations may be used in connection with the methods, apparatuses, and computer programs described herein, including configurations that combine, omit, and/or add aspects and/or components.

The communication system 200 includes a communication network 205, one or more access points (APs) 210 (e.g., an AP 210a and an AP 210-b), and one or more non-AP stations (STAs) 215 (e.g., STA 215-a, STA 215-b, STA 215-c, and STA 215-d). The communication system 200 is a type of network where at least one link is wireless, and provides voice, video, and/or data services to a plurality of devices. The communication network 205 may be a wireless communication network, a wireless local area network, a Wi-Fi network, or another type of communication network. The communication network 205 is illustrated as providing communication services to the one or more STA 215 via the one or more APs 210. The one or more STA 215 may be enabled for voice services, video services, data services, VR services, MR services, AR services, XR services, Internet of Things (IoT) services, and/or one or more other services. In some embodiments, the communication network 200 or components thereof can be configured to communicate with the one or more STA 215 and/or the one or more APs 110 over multiple different frequency bands, sub-bands thereof, and/or the like.

The one or more STAs 215 may be one or more client devices, such as one or more non-AP STAs, connected to the one or more APs 210. For example, the STA 215-a and the STA 215-b may be connected to the AP 210-a. Additionally, the STA 215-c and the STA 215-d may be connected to the AP 210-b. In some examples, the one or more APs 210 may be mobile access points (mAPs) with controlled network functionality. In such examples, a configuration comprising a mAP and a STA may be implemented based on Wi-Fi Direct or another type of network connection. In some examples, a device may simultaneously operate as a non-AP STA and as an AP. One such an example case is in a multi-AP network, which includes two or more devices that may act as APs and use Wi-Fi for the wireless backhaul connectivity based on a non-AP STA–AP connection model. In some examples, a device may simultaneously operate as part of a peer-to-peer connection based on Wi-Fi Direct or Wi-Fi Aware.

In some embodiments, communication between the one or more STAs 215 and the one or more APs 210 may provide the one or more STAs 215 access to the communication network 205 and/or may enable communication therewith. In some embodiments, the one or more APs 210 may provide wireless connectivity for the one or more STAs 215 according to the Wi-Fi standards, such as those that are a subset of the IEEE 802 family of standards. For example, the one or more APs 210 may provide wireless connectivity for the one or more STAs 215 according to the MAC and PHY specifications for Wi-Fi access points defined by IEEE 802.11 for transmitting and receiving data in frequency bands such as 2.4 GHz, 3.6 GHz, 5 GHz, 6 GHz, 60 GHz, and/or the like. The one or more APs 210 and the one or more STAs 215 may communicate through the transmission of frames, including data frames, beacon frames, management frames, and/or control frames, which may be transmitted in unicast messages, broadcast messages, or multicast messages. The 802.11 standards define an inter-frame space (IFS) as the nominal time (in microseconds (µs)) that the MAC and PHY use to receive the last symbol of a frame, process the frame, and respond with the first symbol of a response frame (e.g., the earliest possible response frame). In some embodiments, one or more STAs 215 may be configured to be in a wireless connection with at least one Wi-Fi AP (e.g., AP 210). It is to be appreciated that a Wi-Fi AP may be implemented by various entities and/or types of entities, for example, such as APs, mAPs, access nodes, nodes, hosts, servers, base stations, and/or other entities suitable for such usage.

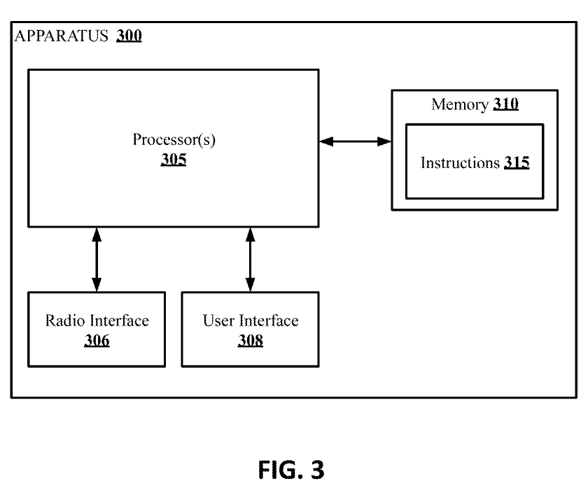

In some examples, the communication system 200 may support radio frequency sensing during IFS. In some examples, the communication system 200 may include a transceiver for transmitting and/or receiving signals. The transceiver may be implemented as a single integrated circuit (e.g., using a single application-specific integrated circuit (ASIC) or field-programmable gate array (FPGA)) or as a system-on-a-chip (SOC) that includes different modules for implementing the functionality of the transceiver. In some embodiments, the transceiver may include a processor and/or a memory (e.g., such as processor 305 and/or memory 310, further described with respect to FIG. 3). The processor 305 may be used to execute instructions stored in the memory 310 and/or to store information in the memory 310, for example, such as the results of the executed instructions.

The one or more APs 210 may include transceivers for transmitting and/or receiving signals, for example, over a backbone and/or over an access interface. A transceiver may be implemented as a single integrated circuit (e.g., using a single ASIC or FPGA) or as a SOC that includes different modules for implementing the functionality of the transceiver. In some embodiments, the transceiver of an AP 210 may include a processor and/or a memory (e.g., such as processor 305 and/or memory 310, further described with respect to FIG. 3).

An STA of the one or more STAs 215 may be a client device such as, for example, a client-side user device, a non-AP STA, user equipment (UE), and/or another type of entity configured to communicate with the one or more APs 210. A UE may be a mobile terminal, such as a mobile phone, a smartphone, a pager, a mobile television, a gaming device, a laptop computer, a computer with a mobile broadband adapter, a camera, a tablet computer, a portable digital assistant (PDA), a communicator, pad, a wearable device, a headset, a touch surface, a video recorder, an audio/video player, radio, an electronic book, a positioning device (e.g., global positioning system (GPS) device), a virtual reality device, an augmented reality device, or any combination of the aforementioned. In some embodiments, an AP 210 may include a processor and/or a memory (e.g., such as processor 305 and/or memory 310, further described with respect to FIG. 3).

In some embodiments, the communication system 200 may support latency-sensitive applications at Wi-Fi devices such as the one or more APs 210 and the one or more STAs 215. Such latency-sensitive applications may include virtual reality applications, mixed reality applications, augmented reality applications, and extended reality applications.

In one or more embodiments, a procedure for facilitating the handover between wireless access points of allocations of a shared transmission opportunity supported by the communication system 200 and/or the communication network 205 may be enabled by employing an apparatus 300 as depicted in FIG. 3. The apparatus 300 may be embodied by and/or incorporated into an AP (e.g., the one or more APs 210) as discussed with respect to FIG. 2.

Regardless of the manner in which the apparatus 300 is embodied, the apparatus 300 includes, is associated with, and/or is in communication with: at least one processor 305, at least one memory 310, and a communication interface 315. In one or more embodiments, the apparatus 300 comprises, for example, the at least one processor 305 and the at least one memory 310 storing instructions 315 that, when executed by the at least one processor 305, cause the apparatus 300 at least to perform the method or methods as disclosed herein, and any of the embodiments thereof. In an example, the at least one memory 310 and the instructions 315 (e.g., a computer program code, software), are configured, with the at least one processor 305, to cause the apparatus 300 to perform the method or methods as disclosed herein, and any of the embodiments thereof.

In some embodiments, the processor 305 may be in communication with the memory 310 via a bus for passing information among components of the apparatus 300. The memory 310 may be non-transitory and may include, for example, one or more volatile and/or non-volatile memories. In other words, for example, the memory 310 may be an electronic storage device (e.g., a computer readable storage medium) comprising gates configured to store data (e.g., bits) that may be retrievable by a machine (e.g., a computing device like the processor). The memory 310 may be configured to store information, data, content, applications, instructions, or the like for enabling the apparatus to carry out various functions in accordance with an example embodiment of the present disclosure. For example, the memory 310 could be configured to buffer input data for processing by the processor. Additionally or alternatively, the memory 310 may be configured to store instructions for execution by the processor 305.

The processor 302 may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 310 may be implemented using any suitable data storage technology. The memory may comprise a database for storing data. The memory 310 may be at least in part external to apparatus 300 but accessible to apparatus 300.

The instructions 315 may be comprised in a computer readable medium or a non-transitory computer readable medium. A term non-transitory, as used herein, is a limitation of the medium itself (e.g., tangible, not a signal) as opposed to a limitation on data storage persistency (e.g., random access memory, RAM, vs. read only memory, ROM).

The apparatus 300 comprises a radio interface 306. The radio interface 306 may provide the apparatus 300 with communication capabilities. The radio interface 306 may comprise a receiver configured to receive information in accordance with at least one cellular or non-cellular standard. The radio interface 306 may comprise a transmitter configured to transmit information in accordance with at least one cellular or non-cellular standard. The receiver may comprise more than one receiver. The transmitter may comprise more than one transmitter. The radio interface 306 may comprise a transceiver configured to receive and transmit information in accordance with at least one cellular or non-cellular standard. The transceiver may comprise more than one transceiver.

The apparatus 300 may optionally comprise a user interface 308 comprising, for example, at least one of a keypad, a microphone, a touch display, a display, a speaker, etc. The user interface 308 may be used to control the apparatus by the user. The user interface 308 may be external to the apparatus 300. For example, the apparatus 300 may be connected to another device, such as a computer, either via wireless or wired connection, and the apparatus 300 is controlled by the user via the computer.

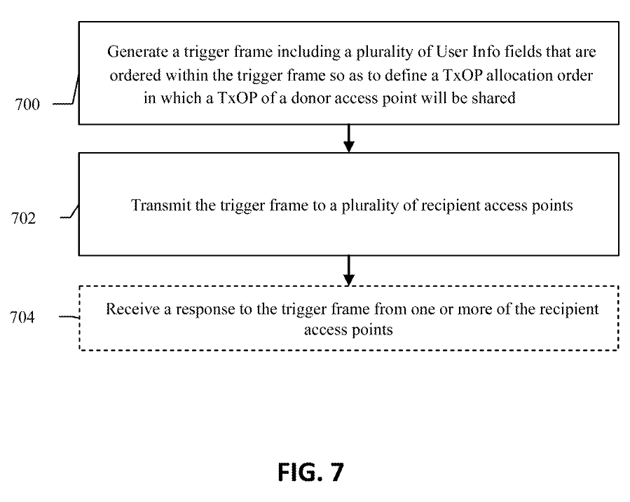

The apparatus 300 may be embodied by or otherwise associated with an access point. As another example, the apparatus is comprised in such an access point, e.g. as a chipset configured to control the access point. The apparatus 300 embodied by or otherwise associated with an access point may be caused or configured to perform at least the method of FIGS. 7-12 and/or any one or more of the embodiments described.

In an embodiment, at least some of the processes described herein may be carried out by an apparatus comprising means for carrying out at least some of the described processes. Means for performing method steps as disclosed herein may include software and/or hardware components of the apparatus 300. For example, the at least one processor 305, the memory 310, and instructions, such as for example the computer program code form means for carrying out the method or methods as disclosed herein, and any of the embodiments thereof. As used herein the term “means” is to be construed in singular form, e.g., referring to a single element, or in plural form, e.g., referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

A method, apparatus and computer program product are provided in accordance with an example embodiment in order to aggregate multiple TxOP handover operations into a single control exchange. In this regard, after an AP has gathered information from its coordinating APs regarding their desire to share its TxOP and the state of their buffers, and completed its own uplink (UL) and downlink (DL) transmissions with its associated non-AP STAs, the AP may transmit a single trigger frame to multiple recipient APs at one time. The trigger frame identifies the donor AP that is sharing the TxOP, defines the frequency resources and the allocation start times of the TxOP allocations to the recipient APs, and also defines the duration of the TxOP allocations to the recipient APs. The trigger frame may also specify the manner in which the recipient APs should provide the responses, thereby enabling the recipient APs to reply, such as either sequentially or simultaneously. This may include specifying a protocol which they should follow to determine when/where to transmit their responses or actual resource allocations for those responses. Thereafter, in an instance in which a respective recipient AP that is sharing the TxOP has completed its use of the TxOP prior to the end of its TxOP allocation, the recipient AP may relinquish the TxOP by triggering a handover to another recipient AP that is next in the TxOP allocation order. In addition, if a recipient AP cannot utilize its TxOP whatsoever, such as when it is blocked by a different overlapping basic service set (OBSS), the donor AP may trigger a handover of the TxOP to another recipient AP after a pre-defined timeout during which the recipient AP that currently has permission to use the TxOP does not begin transmitting. Thus, a TxOP may be more efficiently shared between a plurality of co-channel APs with reduced signalling overhead and reduced airtime required for the handover of the allocated portions of the TxOP.

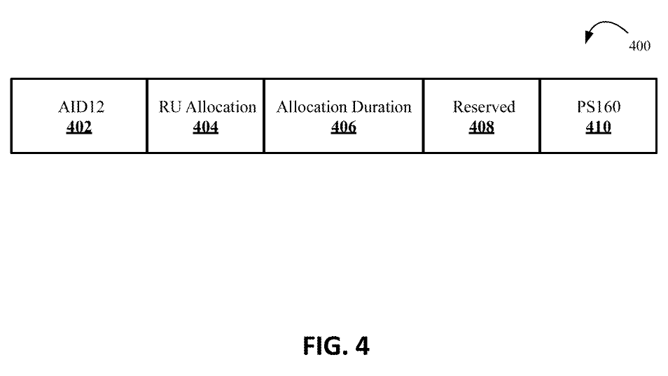

As shown in FIG. 4, the trigger frame transmitted by a donor AP that is sharing its TxOP with its coordinating APs includes one user information field (hereinafter referenced as a User Info field) 400 for each of the coordinating APs. Once a donor AP chooses to share its TxOP with a coordinating AP, the coordinating AP becomes a recipient AP. Each User Info field 400 includes dedicated information carried by various elements of the User Info field. In this regard, the User Info field 400 includes a subfield AID12 402 that provides the identity of a particular recipient AP. The User Info field 400 also includes a resource unit (RU) allocation 404. The RU allocation 404 includes the frequency resources that the recipient AP can utilize, namely, the channels that the recipient AP can use. The RU allocation also includes the allocation start time at which the TxOP allocation to a respective recipient AP commences. In this regard the allocation start time may be a specific time or a relative time, such as a time relative to another action or another point in time. The User Info field 400 may also include the allocation duration subfield 406 indicating the length of time that the recipient AP can utilize the frequency resources indicated by the RU allocation subfield. The duration identified in subfield 406 cannot, however, exceed the duration between the allocation start time of the respective recipient AP and the allocation start time of the recipient AP that immediately follows the respective recipient AP in the TxOP allocation order. In the illustrated embodiment, the User Info field 400 also includes a plurality of reserved bits 408 and a subfield designated PS160 410 that indicates whether the recipient AP that is associated with the User Info field 400 provide additional frequency allocation details.

In order to efficiently share a TxOP with multiple recipient APs in a sequential manner, techniques are provided to allow a recipient AP to determine its position in the TxOP allocation order, that is, the sequential order in which the TxOP will be shared with the different recipient APs. At least some of these techniques also allow a respective recipient AP to identify the particular recipient APs that immediately precede and/or immediately follow the respective recipient AP in the TxOP allocation order.

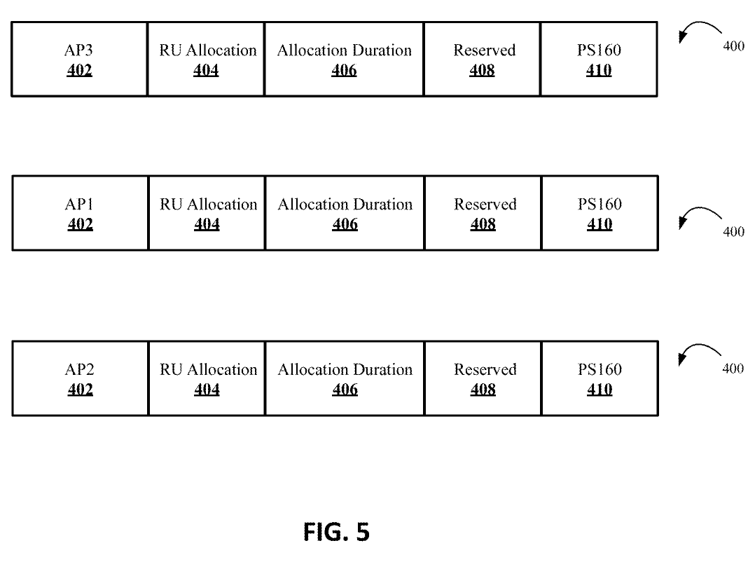

For example, the trigger frame may include a plurality of User Info fields, one of which is associated with each of the recipient APs to which the trigger frame is to be transmitted. The User Info fields may be positioned or arranged in the trigger frame in an order that defines the TxOP allocation order of the recipient APs. Referring to FIG. 5, for example, in which a donor AP that is sharing a TxOP intends to share the TxOP with three coordinating APs designated AP1, AP2 and AP3, the User Info fields for AP1, AP2 and AP3 may be positioned within the trigger frame in an order that is identical to the TxOP allocation order for the recipient APs. In this example, the User Info field for AP3 is provided first followed by the User Info field for AP1 and then the User Info field for AP2. As such, the TxOP will be shared initially with AP3 prior to being shared with AP1 and finally AP2.

In this embodiment, a recipient AP may identify its position in the TxOP allocation order by determining the order of its User Info field within the trigger frame. Additionally, a respective recipient AP can determine the recipient AP that immediately precedes and/or immediately follows the respective recipient AP by reference to the User Info fields that immediately precede and/or immediately follow the User Info field for the respective recipient AP.

In another embodiment, a subfield, such as an allocation order subfield, may be added to the User Info field in order to define the TxOP allocation order for the respective recipient AP with which the User Info field is associated. The subfield, such as the allocation order subfield, provides the respective recipient AP with its position in the TxOP allocation order. As such, the value of the allocation order subfield may be equal to the position of the respective recipient AP in the TxOP allocation order. For example, if the TxOP allocation order for AP1, AP2 and AP3 is AP3 followed by AP1 and AP2, the allocation order subfield for the User Info field of AP1 would have a value of 2, the allocation order subfield of the User Info field for AP2 would have a value of 3 and the allocation order subfield of the User Info field for AP3 would have a value of 1. With reference to the allocation order subfield of this example embodiment, a recipient AP can identify its position in the TxOP allocation order by determining the value of the allocation order subfield which equals the position. Additionally, a respective recipient AP can identify the recipient APs that immediately precede the respective recipient AP and/or that immediately follow the respective recipient AP by reviewing the allocation order subfields of the User Info field for the other recipient APs and determining the recipient APs having User Info fields with values of the allocation order subfield that immediately proceed and/or immediately follow the value in the allocation order subfield of the User Info field of the respective recipient AP.

In a further embodiment, the reserved bits 408 of a User Info field 400 that is associated with a respective recipient AP may be used for the new allocation order subfield, which indicates the position of the respective recipient AP in the TxOP allocation order. For example, the value provided by the reserved bits 408 can identify the position of the respective recipient AP in the TxOP allocation order such that the respective recipient AP can determine its position in the TxOP allocation order by referencing the value of the reserved bits 408 and can identify the recipient APs that immediately precede and/or immediately follow the respective recipient AP by reviewing the reserved bits 408 of the User Info fields 400 for the other recipient APs to identify the values that immediately precede and/or immediately follow the value of the reserved bits of the User Info field for the respective recipient AP. As the number of recipient APs that can share in a TxOP is generally relatively small, the number of reserved bits 408 that are utilized for the allocation order subfield, which identifies the TxOP allocation order of a recipient AP can also be relatively small, such as one, two or three bits.

In another example embodiment, a recipient AP can identify the TxOP allocation order by reference to the allocation start times provided by the RU allocation subfield 404 of the User Info field 400. In this regard, the RU allocation subfield 404 identifies the allocation start time of the portion of a TxOP that is allocated to a respective recipient AP, such as either in terms of a specific time or a relative time, such as relative to another point in time or to another action. The recipient AP can therefore determine its allocation start time as well as the allocation start times of the other recipient APs based upon a review and consideration of the allocation start times provided by the RU allocation subfields 404 of the User Info fields 400 of the recipient APs. Based upon the allocation start times for the plurality of recipient APs, the respective recipient AP can determine its position in the TxOP allocation order by organizing the plurality of allocation start times in order and then determining the position of the allocation start time for the respective recipient AP relative to the allocation start times of the other recipient APs. Additionally, the respective recipient AP can identify the recipient APs that immediately precede and/or immediately follow the respective recipient AP in the TxOP allocation order by identifying the allocation start times of other recipient APs that immediately proceed and/or immediately follow the allocation start time of the respective recipient AP.

The method, apparatus and computer program product of an example embodiment are also configured to relinquish access to the TxOP prior to the end of the TxOP allocation such as in an instance in which a recipient AP completes its transmissions prior to the end of its TxOP allocation. In addition, if a respective recipient AP cannot utilize its TxOP whatsoever, such as when it is blocked by a different overlapping basic service set (OBSS), the donor AP is able to trigger a handover of the TxOP to another recipient AP if the respective recipient AP does not begin transmitting within a predefined time out of when it is given access to the TxOP. In this embodiment, the recipient APs are configured to recognize the early relinquishment of the TxOP by one of the recipient APs and to permit another recipient AP that is next in the TxOP allocation order to commence its use of the TxOP earlier than otherwise scheduled by the allocation start time of this other recipient AP. The early relinquishment and early use of an allocated portion of a TxOP provides for more efficient use of the TxOP and enhanced signaling by the coordinating APs.

In one embodiment, the TxOP return frame that is transmitted by a recipient AP upon its early relinquishment of the TxOP may be broadcast. In this embodiment, the recipient AP that is relinquishing its access to the TxOP includes its identity in the TxOP return frame, but does not identify another recipient AP such as the recipient AP that is next in the TxOP allocation order. In this embodiment, a respective recipient AP will have identified the recipient AP that immediately precedes it in the TxOP allocation order. As such, a respective recipient AP that receives a TxOP return frame that identifies the recipient AP that immediately precedes the respective recipient AP in the TxOP allocation order will determine that the TxOP return frame is handing over the TxOP to the respective recipient AP. The respective recipient AP can then commence its use of the TxOP earlier than scheduled by the allocation start time provided in the RU allocation 404 of the user allocation field 400 of the respective recipient AP.

In another embodiment, the TxOP return frame transmitted by a recipient AP that is relinquishing its the TxOP prior to the end of its TxOP allocation is broadcast or multicast and identifies the recipient AP that is next in TxOP allocation order. In an instance in which this TxOP return frame is multicast, the TxOP return frame may be multicast to the donor AP and to the recipient AP that is next in the TxOP allocation order. In this embodiment, the recipient AP that is relinquishing the TxOP prior to the end of its TxOP allocation identifies the recipient AP that immediately follows it in the TxOP allocation order in the TxOP return frame that is broadcast or multicast.

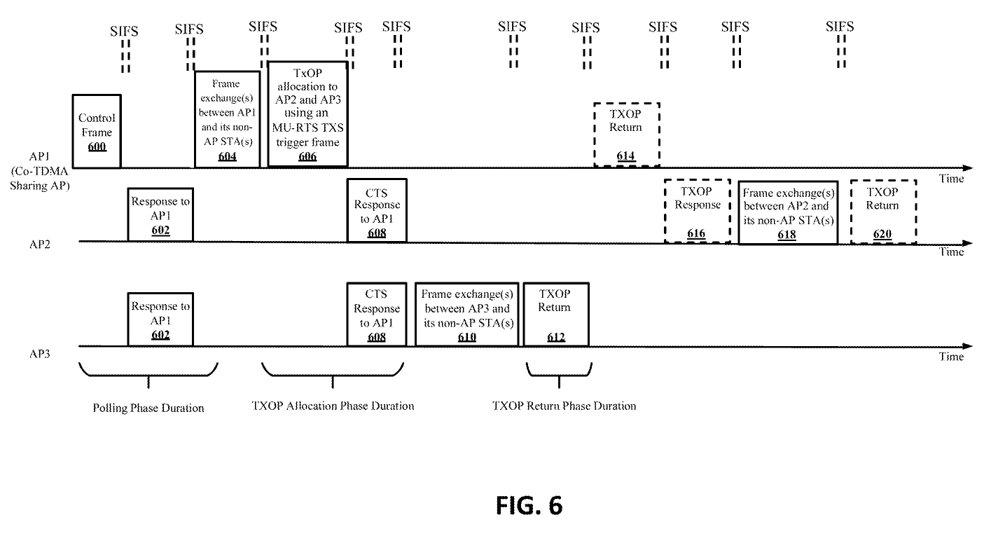

In some embodiments, such as depicted in FIG. 6, in an instance in which the donor AP, AP1, receives a TxOP return frame 612 from a recipient AP, AP3, that is not last in the TxOP allocation order, the donor AP, AP1, may be configured to broadcast an additional TxOP return frame 614. For example, the donor AP may wait a predefined period of time, such as 1 short interframe space (SIFS), and may then broadcast an additional TxOP return frame. The broadcast of the additional TxOP return frame by the donor AP that is sharing the transmission allocation may be done for various purposes. In one embodiment, however, the additional TxOP return frame is broadcast so as to increase the likelihood that the recipient AP that is next in TxOP allocation order will receive the TxOP return frame. In this regard, the donor AP is within communication range of all of the recipient APs, but the recipient APs need not necessarily all be within communication range of each other. As such, it is possible in some instances that the TxOP return frame transmitted by one of the recipient APs is not received by another recipient AP, but the transmission of an additional TxOP return frame by the donor AP will ensure that the recipient AP that is next in the TxOP allocation will receive the TxOP return frame.

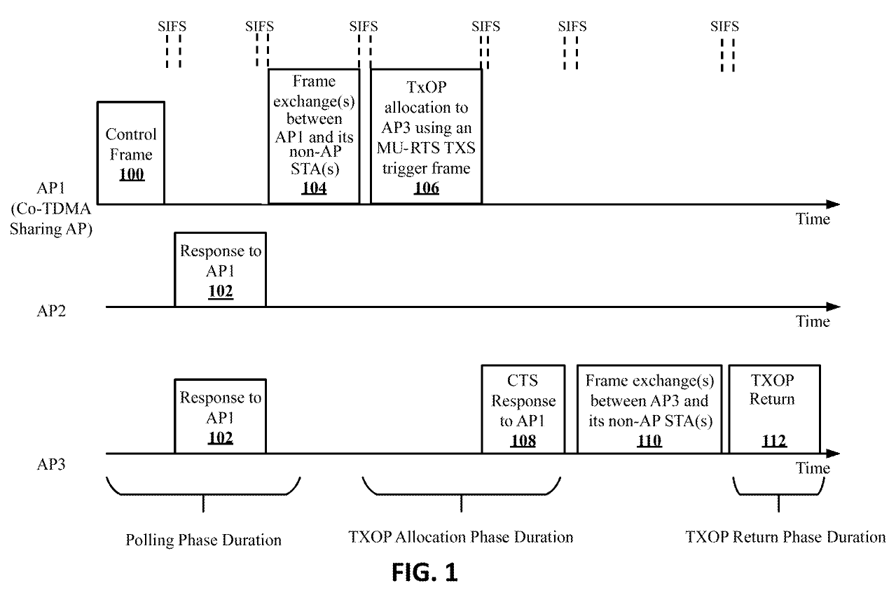

As described in relation to FIG. 1 and as also shown in FIG. 6, during the polling phase of C-TDMA, the donor AP, AP1, transmits an initial control frame 600 to other its coordinated APs. The coordinating APs respond to the initial control frame 600 with a control frame response as shown at 602, such as may be transmitted in accordance with orthogonal frequency division multiple access (OFDMA) using sub channels within the primary, e.g., 20 MHz, channel, indicating whether the coordinating AP would like to share in the TxOP. Following the receipt of the control frame responses from the coordinating APs, AP1 then exchanges frames with one or more associated non-AP stations with which AP1 is in communication as shown at 604, such as by exchanging uplink and downlink transmissions with the associated non-AP stations. In an instance in which the uplink and downlink transmissions of AP1 are completed prior to the end of the TxOP, AP1 transmits at 606 a trigger frame, such as a MU-RTS TXS, to some or all of the coordinating APs that previously responded with a control frame indicating an interest in sharing in the TxOP. Upon receiving the trigger frame and if they are not blocked, the recipient APs return a response to AP1, such as a CTS response. See block 608. The trigger frame from AP1 may also include an indication of the recipient AP to first share in the TxOP, such as AP3 in the illustrated embodiment. The donor AP, AP1, may determine the recipient AP to first share in the TxOP and the allocation order in which other recipient AP(s) will thereafter share in the TxOP. As shown in FIG. 3, AP3 proceeds to utilize the allocated portion of the TxOP for its own downlink and uplink transmissions with one or more associated non-AP stations that are in communication with AP3. See block 610. If AP 3 completes its transmissions prior to expiration of its TxOP allocation, AP3 will transmit a TxOP return frame, as shown at 612, indicating that it is relinquishing the TxOP. In the embodiment of FIG. 6, in an instance in which the donor AP, AP1, receives a TxOP return frame 612 from a recipient AP, AP3, that is not last in the TxOP allocation order, the donor AP, AP1, may be configured to broadcast an additional TxOP return frame 614.

As also shown in the example of FIG. 6, the additional control frame transmitted by AP1 may be received by another recipient AP, that is, AP2. AP2 may then transmit a response, such as a TxOP response 616, to AP1 to confirm receipt of its early access to the TxOP. AP2 then uses the TxOP to exchange frames with its associated non-AP stations as shown in 618. In an instance in which AP2 also concludes its transmissions prior to the end of its TxOP allocation, AP2 transmits a TxOP return frame 620 to indicate that it is relinquishing the TxOP.

In another embodiment, the donor AP may be configured to specify for each recipient AP, whether each recipient AP must wait for a TxOP return frame from the recipient AP immediately preceding it in the TxOP allocation order prior to commencing use of the TxOP prior to the start time specified in its User Info field 400. In this embodiment, the donor AP may also specify for each recipient AP, whether each recipient AP must wait for a TxOP return frame from the donor AP prior to commencing use of the TxOP prior to the start time specified in its User Info field 400. The donor AP may specify this feature on a per recipient AP basis or for the entire group in, for example, the C-TDMA initialization process or dynamically within the MU-RTS TXS trigger frame.

The donor AP may require that one or more of the recipient APs must wait for a TxOP return frame from the donor AP prior to commencing use of the TxOP for various reasons. For example, the donor AP may require that all recipient APs wait for the transmission of a TxOP return frame from the donor AP prior to beginning use of the TxOP prior to the starting times indicated by the User Info fields 400 of the respective recipient APs. In this regard, the recipient APs must await receipt of a TxOP return frame from the donor AP regardless of whether a recipient AP receives a TxOP return frame from the recipient AP preceding it in the TxOP allocation order. In this instance, the donor AP can determine whether to utilize the returned portion of the TxOP for its own transmissions or allow the recipient AP that is next in TxOP allocation order to commence use of the TxOP prior to the starting time defined by the RU allocation 404 of its User Info field 400.

As another example, during the initialization process, the donor AP may determine which of the recipient APs are within communication range of each other. In this instance, the donor AP may be configured to direct that a recipient AP that is within communication range of another recipient AP that immediately precedes it in the TxOP allocation order may begin use of the TxOP in response to receiving a TxOP return frame from the recipient AP that immediately precedes it, such as by beginning use of the TxOP one SIFS following receipt of the TxOP return frame from the immediately preceding recipient AP. In this regard, the recipient AP need not await receipt of a TxOP return frame from the donor AP since the recipient AP will receive the TxOP return frame directly from the preceding recipient AP. In fact, the donor AP need not necessarily transmit a TxOP return frame in this instance, thereby further reducing signaling overhead and channel idle time and improving overall network efficiency.

In another embodiment in which the donor AP receives a TxOP return frame from a recipient AP that is not last in the TxOP allocation order, the donor AP may be configured to determine not to broadcast a TxOP return frame for one or more predefined reasons. For example, in an instance in which the recipient AP that is next in TxOP allocation order has been determined to be within communication range of the recipient AP that immediately precedes it in the TxOP allocation order, the donor AP may determine not to transmit another TxOP return frame since the recipient AP to which the TxOP is being provided early will receive the TxOP return frame directly from the immediately preceding recipient AP that is relinquishing the TxOP early.

As another example, the donor AP may be configured to send an additional TxOP return frame, either always or at least for the specific recipient AP that is next in TxOP allocation order unless the donor AP determines that the time remaining prior to the TxOP allocation start time of the recipient AP that is next in the TxOP allocation order is less than a predefined threshold. In this instance in which the time remaining prior to the TxOP allocation start time of the next recipient AP to share in the TxOP is less than the threshold time, the additional TxOP return frame will not be sent, thereby conserving network resources while the next recipient AP is ensured to commence its use of the TxOP by its predefined TxOP allocation start time.

In another example, the donor AP may be configured to send an additional TxOP return frame, either always or at least for the specific recipient AP that is next in the TxOP allocation order unless the donor AP determines that it would like to use the remaining portion of the TxOP allocation that was relinquished for its own transmissions. The donor AP of this embodiment may use the remaining portion of the current TxOP allocation until the TxOP allocation start time of the recipient AP that is next in TxOP allocation order.

In a further embodiment, a TxOP access timeout may be defined, such as by the donor AP. In this embodiment, if a recipient AP does not transmit within a predefined time of when the recipient AP is first given access to the TxOP, which is either at the recipient’s TxOP allocation start time or one SIFS after the recipient AP receives a TxOP return frame from the required AP (either the recipient AP preceding it in the TxOP allocation order or the donor AP), the donor AP may transmit, such as by broadcasting or multicasting, a TxOP return frame indicating that the recipient AP that is next in TxOP allocation order can commence its use of the TxOP early (since the preceding coordinating AP is not making use of the TxOP). The TxOP access timeout may be, for example, n*SIFS. The value of n may be a system parameter or may be determined during initialization of C-TDMA between the donor AP and the recipient APs. The use of a shared TxOP access timeout avoids having the TxOP sit idle in an instance in which the recipient AP given access to the TxOP currently cannot take advantage of the TxOP, such as due to Overlapping Basic Service Set (OBSS) transmissions.

In a further embodiment, in an instance in which a recipient AP cannot utilize its TxOP allocation, such as in an instance in which the frame to be transmitted by the recipient AP does not fit within the allocation, the recipient AP may sit idle and allow the TxOP access timeout to expire such that the donor AP may transmit a TxOP return frame to allow the recipient AP that is next in TxOP allocation order to commence its use of the TxOP early. Alternatively, the recipient AP that cannot utilize its TxOP allocation may immediately transmit a TxOP return frame, such as at the beginning of its allocation, to indicate that it is relinquishing the TxOP, thereby enabling the recipient AP that is next in TxOP allocation order to commence its use of the TxOP early.

FIGS. 7-12 are flowcharts illustrating the operations performed by APs in various embodiments of the present disclosure. It will be understood that each block of the flowcharts and combination of blocks in the flowcharts can be implemented by various means, such as hardware, firmware, processor, circuitry, and/or other communication devices associated with execution of software including instructions, for example one or more computer program instructions. For example, one or more of the procedures described above can be embodied by computer program instructions. In this regard, the computer program instructions which embody the procedures described above can be stored, for example, by the memory 310 of the apparatus 300 employing an embodiment of the present disclosure and executed by the processor 305. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Referring now to FIG. 7, an apparatus 300 of FIG. 3, such as embodied by a donor AP, such as AP1, that is sharing its TxOP, is configured to define the order in which it shares its TxOP amongst a plurality of recipient APs, AP2 and AP3, based upon the ordering of the User Info fields of the recipient APs within a trigger frame. The User Info fields may have various configurations, but in one embodiment include an identification of a respective recipient AP, a resource unit (RU) allocation for the respective recipient AP including frequency resources to be shared with the respective recipient AP and an allocation start time at which a TxOP will be shared with the respective recipient AP, and an allocation duration indicating a length of time that the recipient AP is able to use the frequency resources provided by the RU allocation.

As shown in block 700, the apparatus 300 includes means, such as at least one processor 305 or the like, for generating a trigger frame, such as an MU-RTS TXS trigger frame, including a plurality of User Info fields. Each User Info field is associated with a respective recipient AP of a plurality of recipient APs with which the apparatus 300 is in communication. The User Info fields are ordered within the trigger frame with the ordering of the User Info fields defining a TxOP allocation order in which a TxOP of the apparatus 300 will be shared with one or more of the plurality of recipient APs. The ordering of the User Info fields within the trigger frame may define a unique a TxOP allocation order for each of the plurality of recipient APs.

As shown in block 702, the apparatus 300 also includes means, such as the at least one processor 305, the radio interface 306 or the like, for transmitting the trigger frame to the plurality of recipient APs. In some embodiments, the apparatus 300 additionally includes means, such as the at least one processor 305, the radio interface 306 or the like, for receiving a response to the trigger frame from at least one of the plurality of recipient APs. See block 704. In other embodiments, however, none of the recipient APs may respond to the trigger frame, such as in instances in which each of the recipient APs are blocked from sharing in the TxOP.

In one embodiment, the apparatus 300 also includes means, such as the at least one processor 305, the radio interface 306 or the like, for receiving a TxOP return frame from a recipient AP that currently has access to the TxOP. The TxOP return frame may indicate that the recipient AP is relinquishing the TxOP prior to the end of its TxOP allocation. The apparatus 300 of this example embodiment may also include means, such as the at least one processor 305, the radio interface 306 or the like, for transmitting, in response to receipt of the TxOP return frame from the recipient AP, another TxOP return frame at least to a respective recipient AP that is next in the TxOP allocation order to share the TxOP. In another embodiment, the apparatus 300 may also include means, such as the at least one processor 305, the radio interface 306 or the like, for transmitting, via a unicast, in response to receipt of the TxOP return frame from the recipient AP relinquishing the TxOP, another TxOP return frame to the respective recipient AP that is next in TxOP allocation order. The another TxOP return frame may identify the respective recipient AP that is next in the a TxOP allocation order to share the TxOP of the apparatus 300.

The apparatus 300 of an example embodiment may also include means, such as the at least one processor 305, the radio interface 306 or the like, for providing an indication to the plurality of recipient APs as to whether or which recipient APs are to wait for a TxOP return frame from the respective recipient AP that is immediately preceding the recipient access point in the TxOP allocation order before commencing utilization of the TxOP early (e.g., before its allocation start time) or are to wait for a TxOP return frame from the apparatus 300 indicating relinquishment of the TxOP by the respective recipient AP that is immediately preceding the recipient access point in the TxOP allocation order prior to commencing utilization of the TxOP early (e.g., before its allocation start time).

The apparatus 300 of an example embodiment also includes means, such as the at least one processor 305, the radio interface 306 or the like, to transmit, in response to a failure of the respective recipient AP to utilize the TxOP within a predefined timeout period after gaining access to the TxOP, a TxOP return frame indicating that the TxOP is now being shared with another recipient AP that is next in the TxOP allocation order such that the another recipient access point can begin utilizing the TxOP early (e.g., prior to its allocation start time).

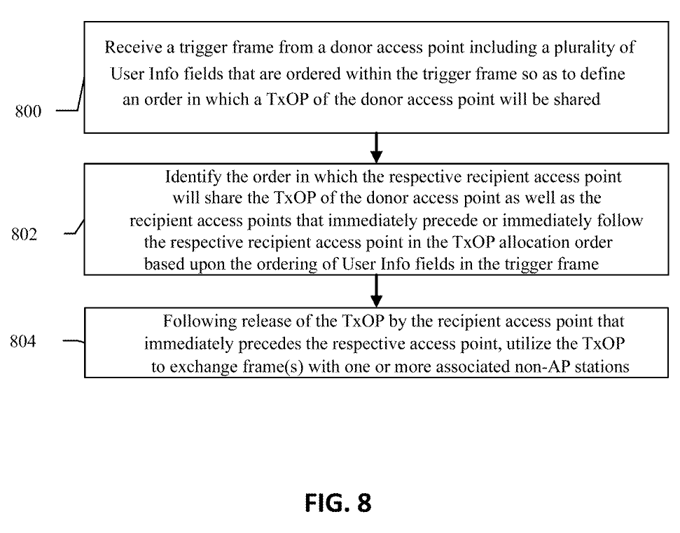

In this embodiment in which the ordering of the User Info fields defines the allocation order in which the recipient APs will share in the TxOP, an apparatus 300, such as may be provided by a recipient AP, may include means, such as at least one processor 305, a radio interface 306 or the like, for receiving a trigger frame, such as an MU-RTS TXS trigger frame, from the donor AP including a plurality of User Info fields. See block 800 of FIG. 8. Each User Info field is associated with a respective recipient AP of a plurality of recipient APs, including the recipient AP that includes the apparatus 300, with which the donor AP is in communication. The User Info fields are ordered within the trigger frame so as to define a TxOP allocation order in which a TxOP of the donor AP will be shared with one or more of the plurality of recipient APs. The ordering of the User Info fields within the trigger frame may define a unique TxOP allocation order for each of the plurality of recipient APs.

As shown in block 802, the apparatus 300 also includes means, such as at least one processor 305 or the like, for identifying the TxOP allocation order in which the TxOP of the donor AP is shared with the apparatus 300 as well as the recipient APs that immediately precede or immediately follow the apparatus 300 in the TxOP allocation order. The apparatus 300 further includes means, such as the at least one processor 305, the radio interface 306 or the like, for commencing utilization of the TxOP earlier than its TxOP allocaaton start time, following release of the shared TxOP by the recipient AP that immediately precedes the apparatus in the TxOP allocation order, to exchange one or more frames with one or more associated non-AP stations with which the apparatus 300 is in communication. See block 804.

The apparatus 300 of an example embodiment includes means, such as the at least one processor 305, the radio interface 306 or the like, for transmitting a TxOP return frame in an instance in which the apparatus 300 relinquishes the TxOP prior to the end of its TxOP allocation. In this embodiment, the apparatus 300 includes means, such as the at least one processor 305, the radio interface 306 or the like, for broadcasting, multicasting or unicasting the TxOP return frame. The TxOP return frame identifies the recipient AP that immediately follows the apparatus in the TxOP allocation order.

In one embodiment, the apparatus 300, such as the at least one processor 305, is configured to identify the recipient APs that immediately precede or immediately follow the apparatus 300 in the TxOP allocation order based on the User Info fields that immediately precede and immediately follow the User Info field of the apparatus 300. In another embodiment, the apparatus 300, such as the at least one processor 305, is configured to receive an indication from the donor AP as to whether the apparatus 300 is to wait for a TxOP return frame from another recipient access point that immediately precedes the apparatus 300 in the TxOP allocation order before commencing utilization of the TxOP prior to the TxOP allocation start time of the apparatus 300 or is to wait for the TxOP return frame from the donor access point indicating the relinquishment of the TxOP by the recipient access point that immediately precedes the apparatus 300 in the TxOP allocation order before commencing utilization of the TxOP prior to the TxOP allocation start time of the apparatus 300.

The apparatus 300 of an example embodiment may also include means, such as the at least one processor 305, the radio interface 306 or the like, for receiving an indication from the donor AP as to whether the apparatus 300 is to wait for a TxOP return frame from another recipient AP that is immediately preceding it in the TxOP allocation order prior to commencing utilization of the TxOP early (e.g., prior to its allocation start time) or is to wait for a TxOP return frame from the donor AP indicating the relinquishment of the allocation by the recipient AP that is immediately preceding in the TxOP allocation order prior to commencing utilization of the TxOP early (e.g., prior to its allocation start time).

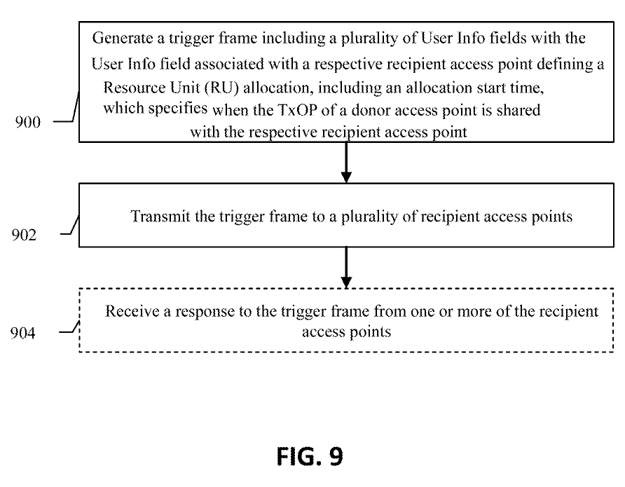

In another embodiment depicted in FIG. 9, an apparatus 300, such as provided by the donor AP, is configured to facilitate determination of the allocation order in which a plurality of recipient APs will share in the TxOP based upon the RU allocation start times in their respective User Info fields. The apparatus 300 includes means, such as at least one processor 305 or the like, for generating a trigger frame, such as an MU-RTS TXS trigger frame, including a plurality of User Info fields. See block 900. Each User Info field is associated with a respective recipient AP of a plurality of recipient APs with which the apparatus 300 is in communication. The User Info field associated with the respective recipient AP defines a resource unit (RU) allocation for the respective recipient AP including an allocation start time at which a TxOP of the apparatus 300 is shared with the respective recipient AP. The allocation start time identified by the RU allocation may be a specific time at which the TxOP of the apparatus 300 is able to be shared with the respective recipient AP, or the allocation start time identified by the RU allocation may be a time defined relative to another point in time or relative to another action.

The RU allocation may also include an indication of frequency resources to be utilized by the respective recipient AP when sharing the TxOP. In this embodiment, each User Info field also identifies a recipient AP with which the User Info field is associated and an allocation duration indicating a length of time that the recipient AP is assigned the frequency resources provided by the RU allocation.

The apparatus 300 also includes means, such as the at least one processor 305, the radio interface 306 or the like, for transmitting the trigger frame to the plurality of recipient APs. See block 902. In some embodiments, as shown in block 904, the apparatus 300 further includes means, such as the at least one processor 305, the radio interface 306 or the like, for receiving a response to the trigger frame from one or more of the recipient APs with which the plurality of User Info fields are associated. In other embodiments, however, none of the recipient APs may respond to the trigger frame, such as in instances in which each of the recipient APs are blocked from sharing in the TxOP.

The apparatus 300 of an example embodiment may also include means, such as the at least one processor 305, the radio interface 306 or the like, for receiving a TxOP return frame from the recipient AP that is currently sharing the TxOP of the apparatus 300. The TxOP return frame indicates that the recipient AP is relinquishing the TxOP prior to the end of its TxOP allocation. In one embodiment, the apparatus 300 may also include means, such as the at least one processor 305, the radio interface 306 or the like, for transmitting, e.g., broadcasting, in response to receipt of the TxOP return frame from the recipient AP relinquishing the TxOP, a TxOP return frame that indicates the recipient AP relinquishing the TxOP. In another embodiment, the apparatus 300 may also include means, such as the at least one processor 305, the radio interface 306 or the like, for transmitting, via a multicast or unicast, in response to receipt of the TxOP return frame from the recipient AP relinquishing the TxOP, a TxOP return frame to the respective recipient AP that is next in TxOP allocation order. The TxOP return frame may identify another respective recipient AP that is next in allocation order.

The apparatus 300 of an example embodiment also includes means, such as the at least one processor 305, the radio interface 306 or the like, for providing an indication to the plurality of recipient APs as to whether or which recipient APs are to wait for a TxOP return frame from a recipient AP that is immediately preceding the respective access point in the TxOP allocation order before commencing utilization of the TxOP early (e.g., prior to its respective allocation start time) or are to wait for a TxOP return frame from the apparatus indicating relinquishment of the TxOP by the recipient APs that are immediately preceding the respective access points in the TxOP allocation order before commencing utilization of the TxOP early (e.g., prior to its respective allocation start time).

The apparatus 300 of an example embodiment additionally includes means, such as the at least one processor 305, the radio interface 306 or the like, for transmitting, in response to a failure of a recipient AP to utilize the TxOP within a predefined time out period after the recipient access point gains access to the TxOP, a TxOP return frame indicating that another recipient AP is able to commence utilizing the TxOP, such as the another recipient AP that immediately follows in TxOP allocation order.

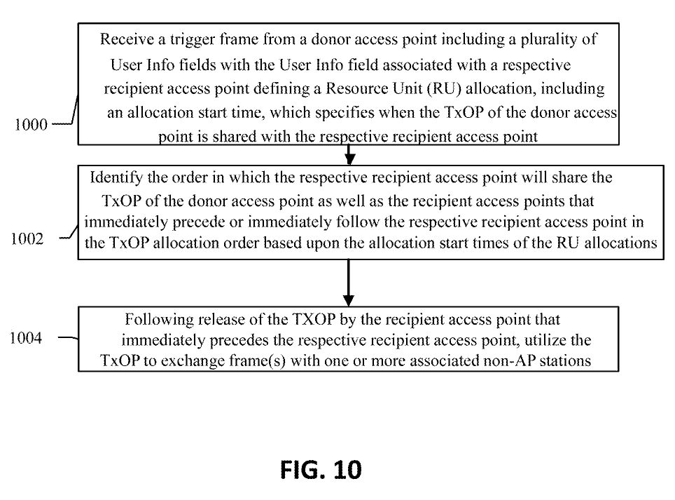

From the perspective of a recipient AP and as shown in block 1000 of FIG. 10, an apparatus 300, such as provided by a recipient AP, includes means, such as the at least one processor 305, the radio interface 306 or the like, for receiving a trigger frame, such as an MU-RTS TXS trigger frame from a donor AP including a plurality of User Info fields. Each User Info field is associated with a respective recipient AP of a plurality of recipient APs, including recipient AP that includes the apparatus 300, with which the donor AP is in communication. The User Info field associated with the apparatus 300 defines a resource unit (RU) allocation for the apparatus 300 including an allocation start time at which a TxOP of the donor AP is able to be shared with the apparatus 300. The allocation start time identified by the RU allocation may be a specific time at which the TxOP of the apparatus is able to be shared with the respective recipient AP. Or, the allocation start time identified by the RU allocation may be a time defined relative to another point in time or relative to another action.

The RU allocation may also include an indication of frequency resources to be utilized by the apparatus 300 when sharing the TxOP. Also, each User Info field may also identify a recipient AP with which the User Info field is associated and an allocation duration indicating a length of time that the recipient AP is able to use the frequency resources provided by the RU allocation.

The apparatus 300 also includes means, such as the at least one processor 305 or the like, for identifying the allocation order in which the apparatus 300 is shared the TxOP of the donor AP as well as the recipient APs that immediately precede or immediately follow the apparatus 300 in the TxOP allocation order based upon the allocation start times of the RU allocations of the plurality of User Info fields. See block 1002. The apparatus 300 further includes means, such as the at least one processor 305, the radio interface 306 or the like, for commencing utilization of the TxOP prior to the TxOP allocation start time of the respective recipient access point, following release of the TxOP by the recipient AP that immediately precedes the apparatus in the TxOP allocation order, to exchange one or more frames with one or more associated non-AP stations with which the apparatus 300 is in communication. See block 1004.

In an example embodiment, the apparatus 300 also includes means, such as the at least one processor 305, the radio interface 306 or the like, for transmitting a TxOP return frame in an instance in which the apparatus 300 relinquishes the TxOP prior to the end of its TxOP alloaction. In this embodiment, the apparatus 300 may include means, such as the at least one processor 305, the radio interface 306 or the like, for broadcasting the TxOP return frame. The TxOP return frame that is broadcast may identify the recipient AP with which the apparatus 300 is associated that is relinquishing the TxOP. The TxOP return frame may additionally identify another recipient AP that is next to share in the TxOP by immediately following the respective recipient AP in TxOP allocation order.

The TxOP return frame of one embodiment is transmitted by being multicast with the TxOP return frame identifying the donor access point and a recipient access point that immediately follows the respective recipient access point in the TxOP allocation order. In another embodiment, the TxOP return frame is transmitted by being unicast and being addressed to the donor access point.

The apparatus 300 of an example embodiment may also include means, such as the at least one processor 305, the radio interface 306 or the like, for receiving an indication from the donor AP as to whether the apparatus 300 is to wait for a TxOP return frame from another recipient AP immediately preceding the respective recipient access point in the TxOP allocation order before commencing utilization of the TxOP early (e.g., prior to its TxOP allocation start time) or is to wait for a TxOP return frame from the donor AP indicating relinquishment of the TxOP by the recipient AP that is immediately preceding the respective recipient access point in the TxOP allocation order before commencing utilization of the TxOP early (e.g., prior to its TxOP allocation start time).

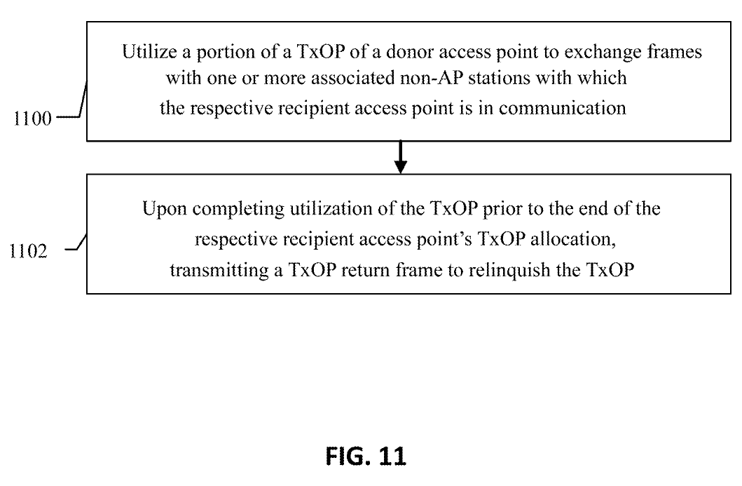

A recipient AP may relinquish the TxOP allocation prior to the end of its TxOP allocation and another recipient AP may commence utilization of the TxOP prior to its scheduled TxOP allocation start time. Referring now to FIG. 11, the apparatus 300, such as may be provided by a recipient AP, may include means, such as the at least one processor 305, the radio interface 306 or the like, for utilizing a portion of a TxOP to exchange frames with one or more associated non-AP stations with which a recipient AP is in communication. See block 1100. As shown in block 1102, the apparatus also includes means, such as the at least one processor 305, the radio interface 306 or the like, for transmitting, upon completing its utilization of the TxOP prior to the end of its TxOP allocation, a TxOP return frame to relinquish the allocation of the TxOP.

In one embodiment, the apparatus 300, such as the at least one processor 305, the radio interface 306 or the like, is configured to transmit the TxOP return frame by broadcasting the TxOP return frame. In this embodiment, the TxOP return frame may include an identity of the recipient AP that is relinquishing the TxOP prior to an end of its TxOP allocation. In another embodiment, the apparatus 300, such as the at least one processor 305, the radio interface 306 or the like, is configured to transmit the TxOP return frame by broadcasting, multicasting or unicasting the TxOP return frame including an identity of another recipient AP, such as another recipient AP that immediately follows the apparatus in TxOP allocation order. In a further embodiment, the apparatus 300, such as the at least one processor 305, the radio interface 306 or the like, is configured to transmit the TxOP return frame by multicasting the TxOP return frame to the donor AP and to another recipient AP that immediately follows the apparatus in the TxOP allocation order. In this embodiment, the TxOP may include an identity of the another recipient AP that is next in TxOP allocation order.

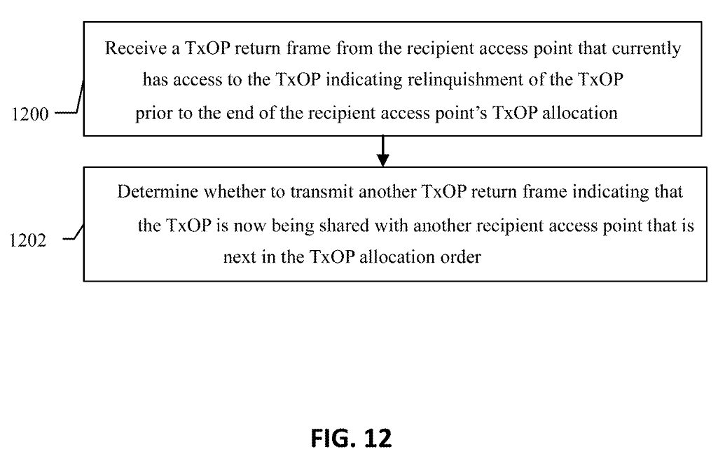

From the perspective of a donor AP that embodies the apparatus 300, the apparatus 300, such as shown in FIG. 12, includes means, such as the at least one processor 305, the radio interface 306 or the like, for receiving a TxOP return frame from a recipient AP that currently has access to the TxOP indicating relinquishment of the TxOP by the recipient AP prior to the end of its TxOP allocation. See block 1200. As shown in block 1202, the apparatus 300 also includes means, such as the at least one processor 305 or the like, for determining whether to transmit another TxOP return frame indicating that the TxOP is now being shared with another recipient AP that is next in the TxOP allocation order prior to the start time of the TxOP allocation assigned to the another recipient AP.

In one embodiment, the apparatus 300, such as the at least one processor 305, is configured to determine whether to transmit another TxOP return frame by determining whether the recipient AP from which the TxOP return frame was received is last in the TxOP allocation order and determining to transmit the another TxOP return frame, such as following a delay by a short interface space (SIFS), other than in an instance in which the recipient AP is last in the TxOP allocation order. In one embodiment, the apparatus 300 is caused to transmit the another TxOP return frame by broadcasting the another TxOP return frame including an identity of at least one of the recipient access point relinquishing the TxOP or the another recipient AP that is next in the TxOP allocation order. In another embodiment, the apparatus 300 is configured to transmit the another TxOP return frame by unicasting the another TxOP return frame to the another recipient AP that is next in the TxOP allocation order.

The apparatus 300 of an example embodiment also includes means, such as the at least one processor 305, the radio interface 306 or the like, for transmitting an indication as to whether the another recipient AP must wait for a TxOP return frame from the recipient access point immediately preceding the another recipient access point in the TxOP allocation order or from the apparatus 300 befoe commencing utilization of the TxOP early (e.g,, prior its allocation start time). In some embodiments, the apparatus 300, such as the at least one processor 302, is configured to determine whether to transmit the another TxOP return frame by determining whether the another recipient AP that is next in the TxOP allocation order is in communication range of the recipient AP that sent the TxOP return frame and determining to transmit the another TxOP return frame only in an instance in which the another recipient AP is outside of the communication range of the recipient AP that sent the TxOP return frame.

In an example embodiment, the apparatus 300, such as the at least one processor 305, is configured to determine whether to transmit the another TxOP return frame by determining whether the time remaining prior to the end of the TxOP allocation of the recipient AP that sent the TxOP return frame satisfies a predefined threshold and determining to transmit the another TxOP return frame only in an instance in which the time remaining exceeds the predefined threshold. The apparatus 300 of an example embodiment also include means, such as the at least one processor 305, the radio interface 306 or the like, for transmitting, in response to a failure of the another recipient AP to utilize the TxOP within a predefined time out period after gaining access to the TxOP, a TxOP return frame indicating that the TxOP is now being shared with a further recipient AP that is next in TxOP allocation order.

As described above, the method, apparatus and computer program product of various example embodiments aggregate multiple TxOP handover operations into a single control exchange, such as a trigger frame, e.g., a MU-RTS TXS trigger frame. As such, a donor AP may transmit a single trigger frame to multiple recipient APs at one time. Thereafter, in an instance in which a respective recipient AP has relinquished its access to the TxOP prior to the end of its TxOP allocation, the donor AP may trigger a handover to another recipient AP that is next in the TxOP allocation order. Thus, a TxOP may be more efficiently shared between a plurality of co-channel APs with reduced signaling overhead and reduced airtime required for the handover of the allocated portions of the TxOP. Indeed, the foregoing techniques to enable an AP to dynamically allocate portions of its TxOP to one or more recipient APs that share the same bandwidth, enhance the spectral efficiency, and reduce the interference. Additionally, the cooperative approach to sharing a TxOP also allows for more robust and efficient management of low latency traffic, such as in Wi-Fi deployments.

As described above, FIGS. 7-12 are flowcharts of various methods that can be carried out by, e.g., the apparatus 300, and/or according to a computer program product, according to an example embodiment of the disclosure. A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments presented herein and that modifications and other embodiments are intended to be included within the scope of the appended claims. Although specific terms are employed herein, they are used in a generic and descriptive sense only and not for purposes of limitation.

What is claimed is:

1. An apparatus comprising at least one processor and at least one memory storing instructions that, when executed by the at least one processor, cause the apparatus to perform at least:
utilizing a portion of a transmission opportunity (TxOP) of a donor access point to exchange frames with one or more associated non-AP stations with which a recipient access point is in communication; and
upon completing utilization of the TxOP prior to an end of the TxOP allocation specified by the donor access point for use by the apparatus, transmitting a TxOP return frame to relinquish the TxOP.

2. An apparatus according to claim 1, wherein transmitting the TxOP return frame comprises broadcasting the TxOP return frame, and wherein the TxOP return frame that is broadcast identifies the apparatus that is relinquishing the TxOP prior to an end of its TxOP allocation.

3. An apparatus according to claim 1, wherein transmitting the TxOP return frame comprises broadcasting, multicasting or unicasting the TxOP return frame, and wherein the TxOP return frame includes an identity of another recipient access point.

4. An apparatus according to claim 3, wherein the another recipient access point immediately follows the apparatus in TxOP allocation order.

5. An apparatus according to claim 1, wherein transmitting the TxOP return frame comprises multicasting the TxOP return frame to the donor access point and to another recipient access point that immediately follows the apparatus in TxOP allocation order.

6. An apparatus comprising at least one processor and at least one memory storing instructions that, when executed by the at least one processor, cause the apparatus to perform at least:
receiving a TxOP return frame from a recipient access point that is currently sharing the TxOP of the apparatus prior to an end of a TxOP allocation of the recipient access point; and
determining whether to transmit another TxOP return frame indicating that the TxOP is now being shared with another recipient access point that is next in an TxOP allocation order prior to an allocation start time assigned to the another recipient access point.

7. The apparatus according to claim 6, wherein determining whether to transmit another TxOP return frame comprises determining whether the recipient access point from which the TxOP return frame was received is last in the TxOP allocation order and determining to transmit the another TxOP return frame other than in an instance in which the recipient access point is last in the TxOP allocation order for the TxOP.

8. The apparatus according to claim 7, wherein the apparatus is further caused to delay by a short interface space (SIFS) prior to transmitting the another TxOP return frame.

9. The apparatus according to claim 6, wherein the instructions, when executed by the at least one processor, further cause the apparatus to transmit the another TxOP return frame by broadcasting the another TxOP return frame, wherein the another TxOP return frame includes an identity of at least one of the recipient access point relinquishing the TxOP or the another recipient access point that is next in the TxOP allocation order.

10. The apparatus according to claim 6, wherein the instructions, when executed by the at least one processor, further cause the apparatus to transmit the another TxOP return frame by multicasting or unicasting the another TxOP return frame to the another recipient access point that is next in the TxOP allocation order.

11. The apparatus according to claim 6, wherein the instructions, when executed by the at least one processor, further cause the apparatus to transmit an indication as to whether the another recipient access point must wait for a TxOP return frame from the recipient access point immediately preceding the another recipient access point in the TxOP allocation order or from the apparatus before commencing utilization of the TxOP prior to a start of the TxOP allocation of the another recipient access point.

12. The apparatus according to claim 6, wherein determining whether to transmit the another TxOP return frame comprises determining whether the another recipient access point that is next in the TxOP allocation order is in communication range of the recipient access point that sent the TxOP return frame and determining to transmit the another TxOP return frame only in an instance in which the another recipient access point is outside of the communication range of the recipient access point that sent the TxOP return frame.

13. The apparatus according to claim 6, wherein determining whether to transmit the another TxOP return frame comprises determining whether time remaining before an end of the TxOP allocation assigned to the recipient access point that sent the TxOP return frame satisfies a predefined threshold and determining to transmit the another TxOP return frame in an instance in which the time remaining exceeds the predefined threshold.

14. The apparatus according to claim 6, wherein the instructions, when executed by the at least one processor, further cause the apparatus, in response to a failure of the another recipient access point to utilize the TxOP within a predefined time out period after the another recipient access point gains access to the TxOP, to transmit a TxOP return frame indicating that the TxOP is now being shared with a further recipient access point that is next in the TxOP allocation order.

15. A method comprising:
utilizing a portion of a transmission opportunity (TxOP) of a donor access point to exchange frames with one or more associated non-AP stations with which a recipient access point is in communication; and
upon completing utilization of the TxOP prior to an end of the TxOP allocation specified by the donor access point for use by a recipient access point, transmitting a TxOP return frame to relinquish the TxOP.

16. The method according to claim 15, wherein transmitting the TxOP return frame comprises broadcasting the TxOP return frame, and wherein the TxOP return frame that is broadcast identifies the recipient access point that is relinquishing the TxOP prior to an end of its TxOP allocation.

17. The method according to claim 15, wherein transmitting the TxOP return frame comprises broadcasting or multicasting the TxOP return frame, and wherein the TxOP return frame includes an identity of another recipient access point.

18. The method according to claim 17, wherein the another recipient access point is next in an TxOP allocation order.

19. The method according to claim 15, wherein transmitting the TxOP return frame comprises multicasting the TxOP return frame to the donor access point and to another recipient access point that is next in TxOP allocation order, wherein the TxOP includes an identity of the another recipient access point that is next in TxOP allocation order.

20. The method according to claim 15, wherein transmitting the TxOP return frame comprises unicasting the TxOP return frame.
